(19) United States
(12) Patent Application Publication
(10) Pub. No.: US 2013/0215135 A1
(43) Pub. Date: Aug. 22, 2013

(54) Image Display Device and Projector

(71) Applicant: Seiko Epson Corporation, (US)

(72) Inventors: Naofumi HIRABAYASHI, Suwa-shi (JP); Shunji MARUYAMA, Azumino-shi (JP)

(73) Assignee: SEIKO EPSON CORPORATION, Tokyo (JP)

(21) Appl. No.: 13/846,636

(22) Filed: Mar. 18, 2013

Related U.S. Application Data
(63) Continuation of application No. 11/470,798, filed on Sep. 7, 2006.

(30) Foreign Application Priority Data
Sep. 7, 2005 (JP) 2005-258850
Sep. 7, 2005 (JP) 2005-258851

(51) Int. Cl. G09G 5/02

(52) U.S. Cl. CPC G09G 5/02
USPC 345/589

(57) ABSTRACT

An image display device for adjusting an image based on a parameter set including a plurality of parameters and displaying the adjusted image, includes a storage section that stores a plurality of the parameter sets, a selection section that prompts to select desired one of the plurality of parameter sets stored in the storage section, and an image adjustment section that obtains the parameter set selected by the selection section and adjusts a display condition of the image based on the obtained parameter set, wherein the selection section displays the parameters included in each of the parameter sets stored in the storage section when prompting to select the desired one of the plurality of parameter sets.

### BACKGROUND

1. Technical Field

The present invention relates to an image display device and a projector both allowing to adjust the display condition of an image to be displayed thereon.

2. Related Art

Most of image display devices for displaying images corresponding to image signals are arranged to allow the user to adjust the image quality by setting parameters representing the brightness, the contrast, and the color of the image. The user can set the parameters as desired in accordance with the audio-visual environment such as the type (still image or moving image) or the content (e.g., movie, sports, or news) of the image, or the room brightness. However, since the parameter setting operation is required every time the image or the audio-visual environment is changed, the more the parameters to be set are, the more cumbersome the operation becomes.

In order for reducing the cumbersomeness of the above operations, there is proposed an image display device (a projector) which is able to store (register) a combination of the various parameters (the parameter set) set thereto in a memory, and in the case of changing the image or the audio-visual environment, set the various parameters easily by retrieving a desired parameter set out of the plurality of parameter sets thus registered (see JP-A-2003-295321 and JP-A-2005-99620, for example). Each of the parameter sets registered in the memory is added with an identifier (a heading such as A, B, C, . . . , or “memory 1,” “memory 2,” . . . ), and either one of the plurality of identifiers is designated for selecting the desired parameter set.

However, since the identifier itself did not include information representing the content (parameters) of the registered parameter set, it was difficult to know the registered content thereof only from the identifier. In order for finding the registered content, it was necessary to once retrieve a target parameter set and then confirm any changes in the image quality thereafter or confirm each of the parameters in the parameter setting screen or the like. Further, if the result of the confirmation shows that the retrieved parameter set was not the desired one, repetition of the above operation (retrieving of the parameter set and the confirmation thereof) was necessary. Namely, it was problematically difficult to specify desired one out of the plurality of parameter sets in retrieving the registered parameter set. Similarly in the case of registering the parameter set, since it was difficult to confirm the content of the registered parameter set, despite the number of the parameter sets to be registered is limited because of restriction of the memory capacity and so on, the same or similar parameter sets were problematically registered.

### SUMMARY

In view of the above problems, a first advantage of the invention is to provide an image display device capable of enhancing convenience in selecting a desired parameter set out of the plurality of parameter sets in the case of retrieving the parameter set. Further, a second advantage of the invention is to provide an image display device and a projector allowing to easily confirm the setting content of the registered parameter set in the case of registering the parameter set.

An image display device according to an aspect of the invention is an image display device for adjusting an image based on a parameter set including a plurality of parameters and displaying the adjusted image, and includes a storage section that stores a plurality of the parameter sets, a selection section that prompts to select desired one of the plurality of parameter sets stored in the storage section, and an image adjustment section that obtains the parameter set selected by the selection section and adjusts a display condition of the image based on the obtained parameter set, wherein the selection section displays the parameters included in each of the parameter sets stored in the storage section when prompting to select the desired one of the plurality of parameter sets.

According to the image display device, the selection section displays the parameters included in each of the parameter sets when prompting to select one of the plurality of parameter sets stored in the storage section. Therefore, it becomes possible to confirm the content of each of the parameter sets, and accordingly, it becomes possible to predict the display condition in the case in which each of the parameter sets is used. As a result, convenience in selecting the desired set out of the plurality of parameter sets can be enhanced.

In this image display device, it is preferable that the selection section categorizes the plurality of parameter sets by the parameters included in each of the parameter sets and displays the plurality of parameter sets when prompting to select the desired one of the plurality of parameter sets.

According to this image display device, the selection section categorizes the plurality of parameter sets by the parameter included in each of the parameter sets when prompting to select the desired one out of the plurality of parameter sets stored in the storage section. Therefore, it becomes easy to find out the parameter set including the desired parameter out of the plurality of parameter sets, thus further enhancing convenience in selecting the parameter set.

An image display device according to another aspect of the invention is an image display device including a plurality of input terminals capable of inputting different types of image signals and an input selection section that selects one of the plurality of input terminals, and for adjusting an image based on the image signal input to the input terminal selected by the input selection section based on a parameter set including a plurality of parameters and displaying the adjusted image, including a storage section capable of storing a plurality of the parameter sets, a parameter change section that changes the parameters, a registration section that stores, in the storage section, the parameter set including the parameter changed by the parameter change section, a selection section that prompts to select desired one of the plurality of parameter sets stored in the storage section by the registration section, and an image adjustment section that obtains the parameter set selected by the selection section and adjusts a display condition of the image in accordance with the obtained parameter set, wherein the registration section stores input terminal information capable of specifying the input terminal selected by the input selection section in the storage section in conjunction with the parameter set when storing the parameter set, and the selection section obtains and displays the input terminal information corresponding to each of the parameter sets stored in the storage section when prompting to select the desired one of the plurality of parameter sets.

According to the image display device, the selection section displays the input terminal information corresponding to each of the parameter sets when prompting to select one of the plurality of parameter sets stored in the storage section. Therefore, it becomes easy to select the parameter set suitable for a specific type of image signal out of a plurality of parameter sets, thus enhancing convenience in selecting the parameter set.

In this image display device, it is preferable that the selection section categorizes the plurality of parameter sets by the input terminal information corresponding to each of the parameter sets and displays the plurality of parameter sets when prompting to select the desired one of the plurality of parameter sets.

According to the image display device, since the selection section categorizes the plurality of parameter sets by the input terminal information corresponding to each of the parameter sets and displays the plurality of the parameter sets when prompting to select the desired one out of the plurality of parameter sets stored in the storage section, it becomes much easier to find out the parameter set suitable for a specific type of image signal out of the plurality of parameter sets.

An image display device according to still another aspect of the invention is an image display device for adjusting an image based on a parameter set including a plurality of parameters and displaying the adjusted image, and includes a storage section that stores a plurality of the parameter sets, a selection section that prompts to select desired one of the plurality of parameter sets stored in the storage section, and an image adjustment section that obtains the parameter set selected by the selection section and adjusts a display condition of the image based on the obtained parameter set, wherein the selection section displays the parameters included in the parameter set used presently and the parameters included in the parameter set stored in the storage section when prompting to select the desired one of the plurality of parameter sets.

According to this image display device, since the selection section displays the parameters included in the parameter set used presently and the parameters included in the parameter set stored in the storage section when prompting to select the desired one out of the plurality of parameter sets stored in the storage section, it becomes possible to compare the parameters included in both of the parameter sets with each other. This comparison makes it easy to predict the display condition in the case in which each of the parameter sets stored in the storage section is used, thus enhancing convenience in selecting desired one from the plurality of parameter sets.

In this image display device, it is preferable that the selection section displays an image adjusted based on the parameter set used presently, and an image adjusted based on the parameter set stored in the storage section when prompting to select the desired one of the plurality of parameter sets.

According to this image display device, the selection section displays the image adjusted based on the parameter set used presently and the image adjusted based on the parameter set stored in the storage section when prompting to select the desired one from the plurality of parameter sets stored in the storage section. Namely, the display condition in the case in which the parameter set stored in the storage section is used can be confirmed by looking at the actual image, and further compared with the image based on the parameter set in presently use, thus enhancing convenience in selecting desired one out of the plurality of parameter sets.

In this image display device, it is preferable that the selection section displays the image adjusted based on the parameter set used presently, and the image adjusted based on the parameter set stored in the storage section simultaneously.

According to this image display device, since the selection section displays the image adjusted based on the parameter set used presently and the image adjusted based on the parameter set stored in the storage section simultaneously when prompting to select the desired one from the plurality of parameter sets stored in the storage section, it becomes easy to compare the both images with each other.

An image display device according to still another aspect of the invention is an image display device for adjusting an image based on a parameter set including a plurality of parameters and displaying the adjusted image, and includes a parameter change section that changes the parameters, a storage section capable of storing a plurality of the parameter sets, and a registration section that stores, in the storage section, the parameter set including the parameter changed by the parameter change section, wherein the registration section displays, prior to storing the parameter set in the storage section, the parameters included in the parameter set to be stored and the parameters included in the parameter set that has already been stored in the storage section.

According to this image display device, since the registration section displays, prior to storing the parameter set in the storage section, the parameters included in the parameter set to be stored and the parameters included in the parameter set which has already been stored in the storage section, it becomes possible to compare the parameters included in the both parameter sets with each other. As a result, it becomes easy to confirm whether or not a parameter set, which is the same as or similar to the parameter set to be stored, has already been stored, thus it can be suppressed to store a plurality of the same or similar parameter sets.

In this image display device, it is preferable that the registration section displays, prior to storing the parameter set in the storage section, an image adjusted based on the parameter set to be stored and an image adjusted based on the parameter set that has already been stored in the storage section.

According to this image display device, the registration section displays the image adjusted based on the parameter set to be stored and the image adjusted based on the parameter set which has already been stored in the storage section prior to storing the parameter set in the storage section. As a result, the both parameter sets can be compared while looking at the actual images, thus making it much easier to confirm whether or not the same or a similar parameter set has already been stored.

In this image display device, it is preferable that the registration section displays the image adjusted based on the parameter set to be stored, and the image adjusted based on the parameter set that has already been stored in the storage section simultaneously.

According to this image display device, since the registration section displays the image adjusted based on the parameter set to be stored and the image adjusted based on the parameter set which has already been stored in the storage section simultaneously prior to storing the parameter set in the storage section, it becomes easy to compare the both sides.

A projector according to still another aspect of the invention functions as the image display device described above.

Since the projector is able to display an image in a large screen, more and more projectors have recently been used for movie appreciation or the like. Therefore, fine adjustment on the quality of the image is required to the projectors, and the needs for easily registering or retrieving the parameters for performing the image quality adjustment has risen. According to the projector of the aspects of the invention, since the same advantages as the image display device described above can be obtained, it becomes possible to satisfy the needs described above.

### BRIEF DESCRIPTION OF THE DRAWINGS

The invention will now be described with reference to the accompanying drawings, wherein like numbers refer to like elements.

FIG. 1 is a block diagram showing a schematic configuration of a projector according to a first embodiment of the invention.

FIG. 2 is an explanatory diagram for explaining a menu image superimposed by an OSD processing section.

FIG. 3 is an explanatory diagram showing an OSD image displayed in performing an image quality adjustment.

FIG. 4 is an explanatory diagram showing an OSD image displayed in selecting a color mode.

FIG. 5 is an explanatory diagram showing an OSD image displayed in adjusting parameters.

FIG. 6 is an explanatory diagram showing an OSD image displayed in registering or retrieving a parameter set.

FIG. 7 is an explanatory diagram showing an OSD image displayed in registering the parameter set.

FIG. 8 is an explanatory diagram showing an OSD image displayed in retrieving the parameter set.

FIG. 9 is an explanatory diagram showing an OSD image displayed in retrieving the parameter set in a projector according to a second embodiment of the invention.

FIG. 10 is an explanatory diagram showing a projection image of the projectors according to the first and the second embodiments.

FIG. 11 is an explanatory diagram showing an OSD image displayed in registering the parameter set in a projector according to a third embodiment of the invention.

FIG. 12 is an explanatory diagram showing an OSD image displayed in retrieving the parameter set in the projector according to the third embodiment of the invention.

FIGS. 13A and 13B are explanatory diagrams showing projection images of the projectors according to a fourth embodiment.

FIG. 14 is an explanatory diagram showing a projection image of a projector according to a fifth embodiment of the invention.

### DESCRIPTION OF EXEMPLARY EMBODIMENTS

### First Embodiment

An image display device according to a first embodiment of the invention will hereinafter be explained with reference to the accompanying drawings.

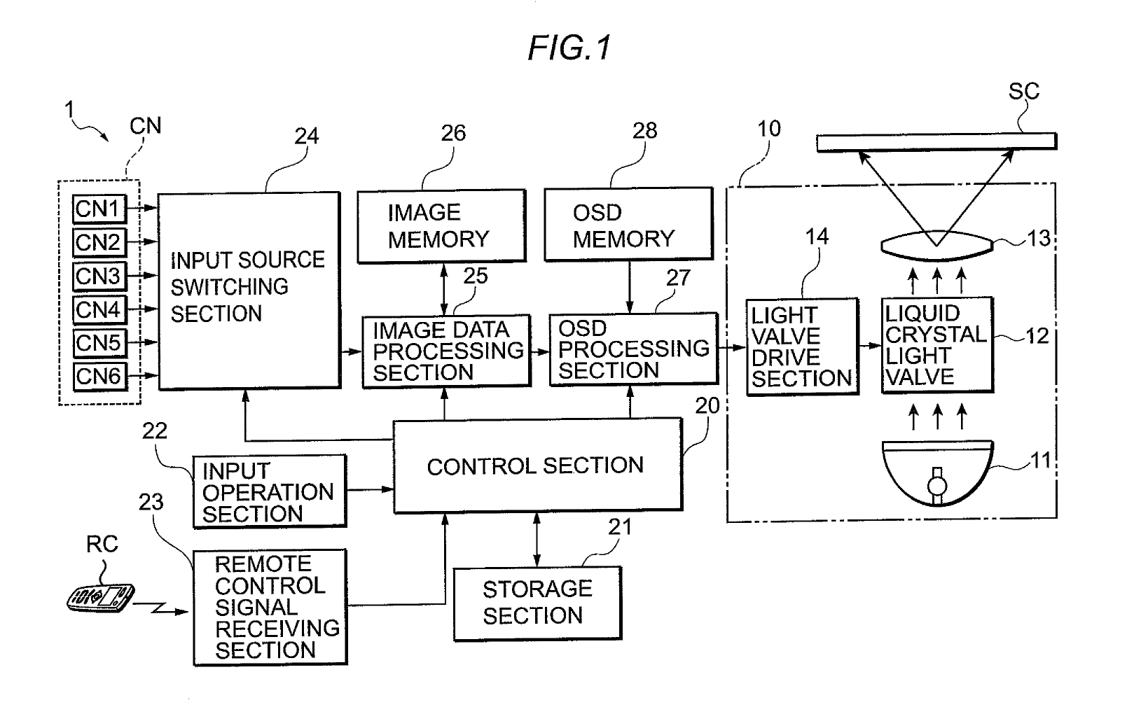

FIG. 1 is a block diagram showing a schematic configuration of a projector as the image display device of the present embodiment.

The projector 1 forms an optical image by modulating an optical beam emitted from a light source in accordance with an image signal input from the outside, and enlargedly projecting the optical image thus formed on a screen SC.

As shown in FIG. 1, the projector 1 is provided with a projection section 10 for performing image projection. The projection section 10 is provided with a light source 11 composed mainly of a discharge light source lamp such as a super high pressure mercury lamp or a metal halide lamp, a liquid crystal light valve 12 as the light modulation device, a projection lens 13, and a light valve drive section 14.

The liquid crystal light valve 12 is provided with a plurality of pixels formed thereon, and modulates the light emitted from the light source 11 for every pixel to form the optical image in accordance with the image signal thus input in response to the light valve drive section 14 driving the liquid crystal light valve 12 according to the image signal. The optical image thus formed is enlargedly projected towards the screen SC by the projection lens 13, and displayed on the screen SC as an image.

It should be noted that, although omitted from the drawings, the optical path between the light source 11 and the liquid crystal light valve 12 is provided with a light separator optical system for separating the light source light into three (red, green, and blue) colored light beams R, G, and B. And, in order for separately modulating the separated colored light beams R, G, and B, three liquid crystal light valves 12 are used as a group. Further, in a light path between the liquid crystal light valves 12 and the projection lens 13, there is disposed a light combining optical system such as a cross dichroic prism for combining the modulated colored light beams R, G, and B, thereby emitting the color optical image thus combined from the projection lens 13.

The projector 1 is further provided with a control section 20, a storage section 21, an input operation section 22, a remote control signal receiving section 23, an input terminal group CN, an input source switching section 24, an image data processing section 25, an image memory 26, an OSD processing section 27, an OSD memory 28, and a remote controller RC.

The control section 20 is mainly composed of a central processing unit (CPU), and functions as a computer. The control section 20 is connected to each of the component 21 through 25, and 27 described above, and controls overall operations of the projector 1 according to the control program stored in the storage section 21.

The storage section 21 corresponds to the storage section of the invention, and is composed of a memory device such as a flash read only memory (ROM). The storage section 21 stores the control program, and is also used for storing various setting values (parameters) and so on.

The input operation section 22 and the remote controller RC are each equipped with a plurality of keys for performing various operations to the projector 1. The keys equipped to the input operation section 22 and the remote controller RC include a power key for turning on/off the power, a menu key (“Menu”) for switching display/nondisplay of the menu image for performing various settings, direction keys (i.e., four keys of “↑,” “↓,” “→,” and “←”) used for moving the cursor on the menu image, a determination key (“Sel”) for designating selection and so on of an item on the menu image, a cancel key (“ESC”) for designating cancellation of the operation, an input source designation key (described in detail later) for switching the input source, and so on. When the user operates the input operation section 22, the input operation section 22 outputs an operation signal corresponding to the operation by the user to the control section 20. Further, when the user operates the remote controller RC, the remote controller RC generates an infrared operation signal corresponding to the operation by the user, and then the remote control signal receiving section 23 receives the signal and transfers it to the control section 20.

The input terminal group CN is provided with input terminals, and is capable of inputting various types of image signals from an external image supplying device (not shown) such as a video player or a personal computer. As the input terminals included in the input terminal group CN, there are cited a component terminal CN1 (hereinafter also referred to as INPUT A terminal) to which a component signal (YCbCr or YPbPr) is input from a video device or the like via three cables, a 15-pin mini D-Sub terminal CN2 (hereinafter also referred to as INPUT B terminal) to which analog RGB signals are input from a personal computer or the like, a D-terminal CN3 (specifically D4-terminal) to which the component signal (YCbCr or YPbPr) is input from a video device or the like via a single cable, an HDMI terminal CN4 to which digital RGB signals are input from a video device or the like, an S-terminal CN5 (hereinafter also referred to as S-video terminal) to which an S-video signal is input from a video device or the like, and a composite terminal CN6 (hereinafter also referred to as video terminal) to which a composite signal is input from a video device or the like. The image signals input to the input terminals CN1 through CN6 are supplied to the input source switching section 24.

The input source switching section 24 selects one input terminal from the six input terminals CN1 through CN6 in accordance with the instruction of the control section 20, and outputs the image signal input to the selected input terminal to the image data processing section 25. The input operation section 22 and the remote controller RC are each provided with six input source selection keys (“INPUT A,” “INPUT B,” D4,” “HDMI,” “S-video,” and “video”) corresponding to the input terminals CN1 through CN6, respectively. And, when the user operates the input source designation keys to designate a desired of the input terminals, the control section 20 instructs the input source switching section 24 to output the image signal form the designated input terminal to the image data processing section 25.

The image data processing section 25 converts the various types of image signals thus input thereto into image data composed of gray scale value of every color (R, G, and B). Further, the image data processing section 25 obtains a plurality of parameters (a parameter set) for adjusting the image quality from the control section 20, and performs various image quality adjustment for adjusting display conditions of the image, such as adjustment of brightness, contrast, sharpness, color, and so on, or the gamma correction on the image data thus converted in accordance with the parameter set. Namely, the image data processing section 25 functions as the image adjustment section of the invention. The image memory 26 is used as a temporary storage of the image data processing section 25 performing the image quality adjusting process described above, and is capable of storing the image data for a plurality of frames (a plurality of screens). The image data processed by the image data processing section 25 to be adjusted in the image quality is output to the OSD processing section 27.

In accordance with an instruction of the control section 20, the OSD processing section 27 performs a process for superimposing an on-screen display (OSD) image composed of a menu image or a message image onto an input image (an image based on the input image signal). The OSD memory 28 stores an image data representing figures, fonts, or the like for forming the OSD image. When the control section 20 outputs OSD image information capable of specifying the OSD image to the OSD processing section 27, the OSD processing section 27 retrieves necessary image data from the OSD memory 28 to generate the OSD image data. Further, the OSD processing section 27 combines the OSD image data with the input image data (an image data based on the input image signal) so that the OSD image is superimposed onto a predetermined position of the input image. The combined image data is then output to the light valve drive section 14. It should be noted that, since the combining process is not performed when no OSD image is displayed, the image data output from the image data processing section 25 is directly supplied to the light valve drive section 14.

The light valve drive section 14 drives the liquid crystal light valve 12 in accordance with the image data input from the OSD processing section 27, thus there is displayed on the screen SC the input image or if necessary, the input image with the OSD image superimposed thereon.

The operation of the projector 1 according to the present embodiment of the invention will hereinafter be described.

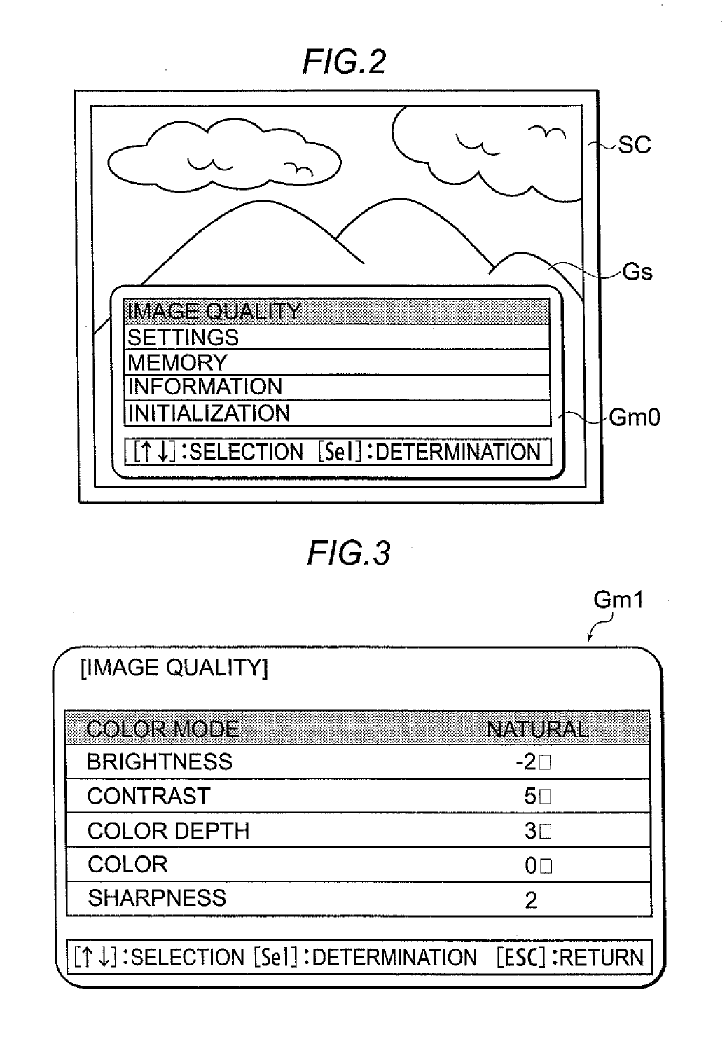

FIG. 2 is an explanatory diagram for explaining a menu image to be superimposed by the OSD processing section 27, wherein there is shown an image projected on the screen SC when the menu key (“Menu”) on either one of the input operation section 22 and the remote controller RC is operated.

In the condition in which the input image Gs is displayed, when the menu key (“Menu”) on either one of the input operation section 22 and the remote controller RC is operated, the control section 20 outputs the OSD image information for displaying the menu image to the OSD processing section 27. In accordance with the OSD image information, the OSD processing section 27 retrieves the OSD image data representing the menu image from the OSD memory 28, and combine it with the input image data. As a result, as shown in FIG. 2, there are displayed on the screen SC the input image Gs and the OSD image (an process selection menu image Gm0) superimposed onto the input image Gs.

In the process selection menu image Gm0, there is listed a plurality of item names (e.g., “image quality,” “settings,” and “memory”), one of these items (“image quality” in FIG. 2) is in a tentative selection state (a state in which the background color is different from other items). It is arranged that the user can change the tentatively selected item by operating the upward/downward keys (“↑” and “↓”) on the input operation section 22 or the remote controller RC. By operating the determination key (“Sel”) after tentatively selecting a desired item, the user can perform setting or information browsing regarding that item. In this case, when “image quality” is selected (by operating the determination key after tentatively selecting the item) in the menu, the control section 20 instructs the OSD processing section to superimpose another OSD image (an image quality adjustment menu image) onto the input image Gs. In the OSD image, the user can set the parameters suitable for performing the image quality adjustment on the input image Gs in accordance with his or her taste.

FIG. 3 is an explanatory diagram showing the OSD image displayed in performing the image quality adjustment, and represents the image quality adjustment menu image displayed on the input image Gs as a superimposing image.

As shown in FIG. 3, in the image quality adjustment menu image Gm1, there are displayed six adjustment item names of “color mode,” “brightness,” “contrast,” “color depth,” “color,” and “sharpness (edge enhancement)” arranged in the vertical direction, wherein the setting values (parameters) are respectively described on the right side of the adjustment item names.

“Color mode” is an item for setting the color tone or the brightness of the image in accordance with the type or the content of the image, the audio-visual environment, and so on. As the parameter, there are defined, for example, “dynamic” suitable for watching in a lighted environment, “living” suitable for watching in the half-light, “natural” capable of reproducing an image faithful to the input signal under the dark environment, “theater” suitable for movie appreciation under the dark environment, and so on, and can be selected therefrom in accordance with the type or the content of the image, the audio-visual environment, and so on. Further, each of the parameters of “brightness,” “contrast,” “color depth,” “color,” and “sharpness” is expressed with a numerical value, and the degree thereof can be fine-adjusted by increasing and decreasing the parameter within a predetermined range (several through several tens of steps). It should be noted that in the present embodiment, “color depth” and “color” are arranged to be able to be adjusted only in other cases than the case in which the image signal input thereto is an RGB type (a digital RGB signal or an analog RGB signal).

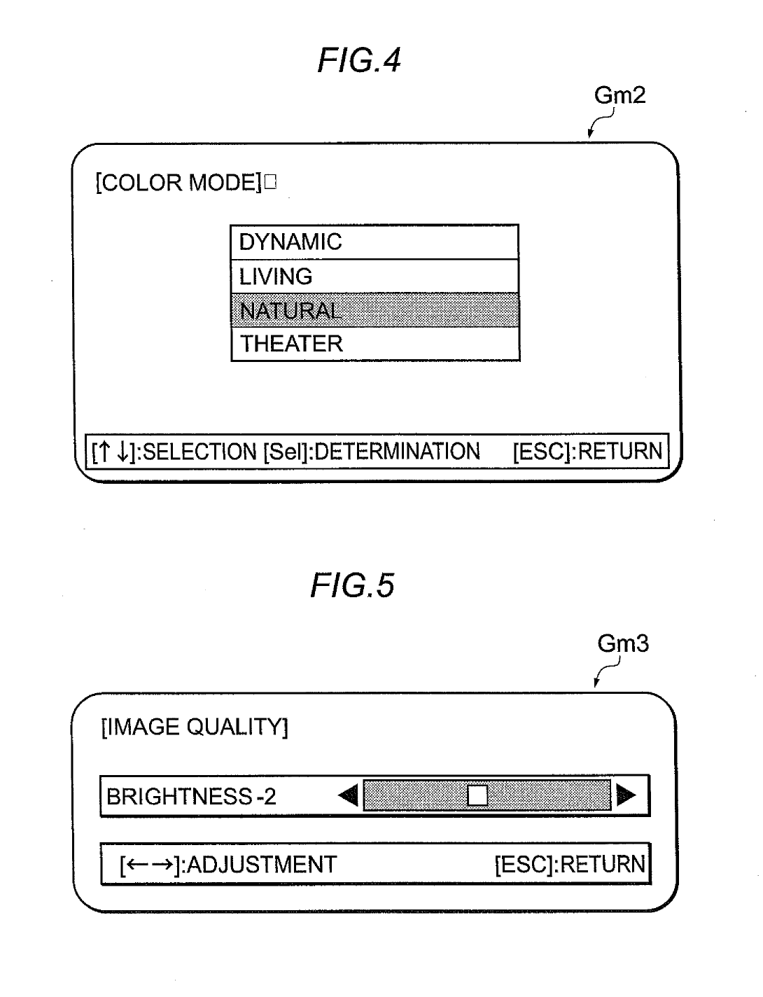

By operating the upward/downward keys (“↑” and “↓”) to tentatively select a desired item in the condition in which the image quality adjustment menu image Gm1 is displayed, and then operating the determination key (“Sel”), the user can change the parameter of the item. In this case, when “color mode” is selected, the control section 20 instructs the OSD processing section 27 to display the color mode selection menu image Gm2 (see FIG. 4) superimposed thereon, thus prompting the user to select either one of the color modes. The user can select a desired color mode with the upward/downward keys (“↑” and “↓”) and the determination key (“Sel”). Further, if other items than the “color mode” are selected in the condition in which the image quality adjustment menu image Gm1 is displayed, the control section 20 instructs the OSD processing section to display the numerical value adjustment menu image Gm3 (see FIG. 5), thus prompting the user to adjust the numerical value. The user can increase and decrease the numerical value with the leftward/rightward keys (“←” and “→”).

When the parameter is changed through the procedure described above, the control section 20 outputs the parameter set composed of all of the parameters to the image data processing section 25. In accordance with the parameter set, the image data processing section 25 starts the image quality adjustment process on the input image data, such as data conversion using a look-up table (LUT) or a filter process using a digital filter.

It should be noted that if the cancel key (“ESC”) is operated in the condition in which either one of the menu image Gm0 through Gm3 is displayed, the control section 20 instructs the OSD processing section 27 to delete the menu image presently superimposed and go back to the previously displayed screen (the same applies to the menu images Gm4 through Gm6 described later). For example, in the condition in which the color mode selection menu image Gm2 or the numerical value adjustment menu image Gm3 is displayed, it goes back to the screen condition with the image quality adjustment menu image Gm1 displayed, or in the condition in which the image quality adjustment menu image Gm1 is displayed, it goes back to the screen condition with the process selection menu image Gm0 displayed. Further, in the condition in which the process selection menu image Gm0 is displayed, it goes back to the condition in which the menu image is not displayed and the input image Gs can be appreciated. Still further, the menu key (“Menu”) is operated in the condition in which either one of the menu image Gm0 through Gm3 is displayed, the control section 20 instructs the OSD processing section 27 to delete the menu image presently superimposed and establish the condition in which the input image Gs can be appreciated (the same applies to the menu images Gm4 through Gm6 described later).

Going back to FIG. 2, the user can store the parameter set in use in the storage section 21 (registration) or retrieve to use a parameter set stored in the storage section 21 (retrieval) by selecting “memory” in the condition in which the process selection menu image Gm0 is displayed.

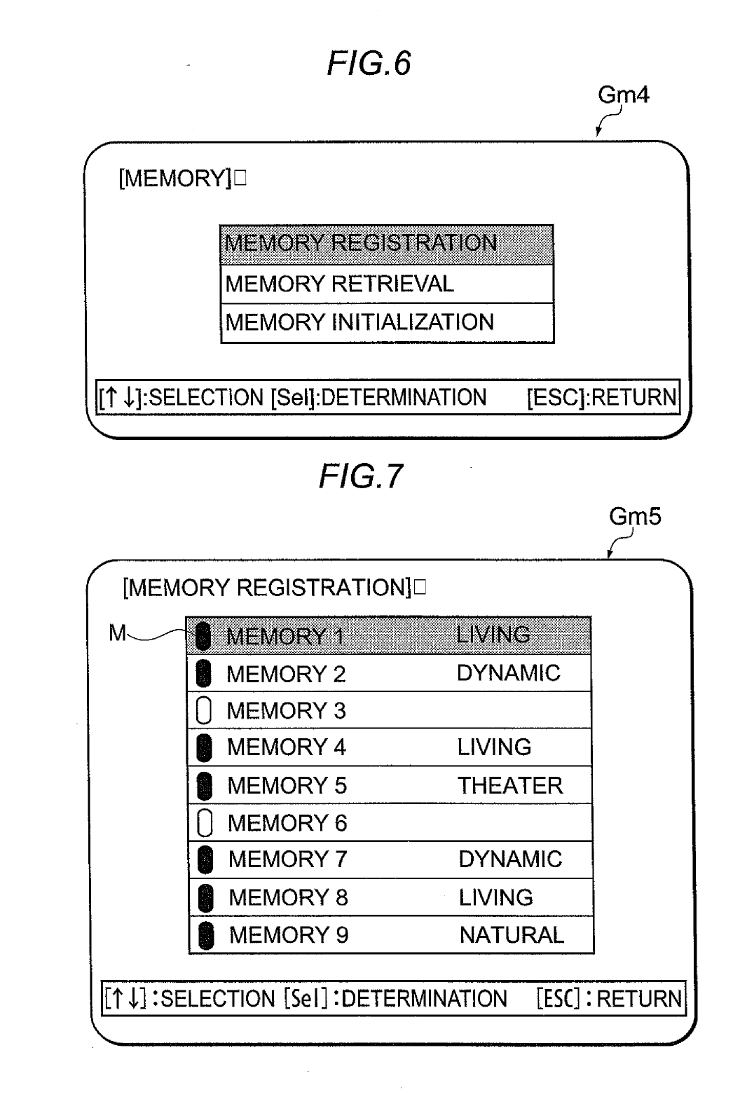

FIG. 6 is an explanatory diagram showing the OSD image displayed in registering or retrieving the parameter set.

In response to the selection of “memory” in the process selection menu image Gm0, the control section 20 instructs the OSD processing section 27 to display the OSD image (a memory operation menu image Gm4) shown in FIG. 6 superimposed on the input image Gs.

In the memory operation menu image Gm4, there are listed three items, namely “memory registration” for registering the parameter set, “memory retrieval” for retrieving the parameter set already registered, and “memory initialization” for restoring the initialized condition of the memory by deleting all of the parameter sets already registered. And, the user can select either one of the items by operating the upward/downward keys (“↑” and “↓,”) and the determination key (“Sel”). If “memory registration” is selected in this moment, the control section 20 instructs the OSD processing section 27 to display the OSD image (a memory registration menu image) for registering the parameter set superimposed on the input image Gs.

FIG. 7 is an explanatory diagram showing the OSD image displayed in registering the parameter set.

In the present embodiment, it is arranged that the storage section 21 can store nine parameter sets, and as shown in FIG. 7, in the memory registration menu image Gm5, there are arranged in the vertical direction identifiers (“memory 1” through “memory 9”) each corresponding to respective one of the nine parameter sets described above. On the left of each of the identifiers, there is attached a mark M representing a registration condition. Whether or not the parameter set corresponding to each of the identifiers has been registered can be judged with the color of the mark M (e.g., black represents the registered condition and white represents the unregistered condition). Further, on the right of the identifier to which a certain parameter set has already been registered, there is described the parameter representing the color mode out of the parameters included in the parameter set so as to make it possible to know the general outline of the parameter set. It should be noted that the described parameter has been retrieved by the control section 20 from the storage section 21 prior to displaying the memory registration menu image Gm5, and the memory registration menu image Gm5 is generated by the OSD processing section 27 in response to the control section outputting the retrieved parameter and so on to the OSD processing section 27 as the OSD image information.

One of the nine identifiers listed in the memory registration menu image Gm5 is in the tentative selection condition, and the user can tentatively select another identifier by operating the upward/downward keys (“↑” and “↓”). By operating the determination key (“Sel”) after tentatively selecting a desired one of the identifiers, the user can store the parameter set in presently use in the storage section 21 in conjunction with the tentatively selected identifier. It should be noted that if the identifier with which another parameter set is registered in conjunction is selected, the parameter set in presently use is overwritten and is registered in conjunction with the present identifier.

Going back to FIG. 6, if “memory retrieval” is selected in the condition in which the memory operation menu image Gm4 is displayed, the control section 20 instructs the OSD processing section 27 to display the OSD image (a memory retrieval menu image) for retrieving the registered parameter set superimposed on the input image Gs.

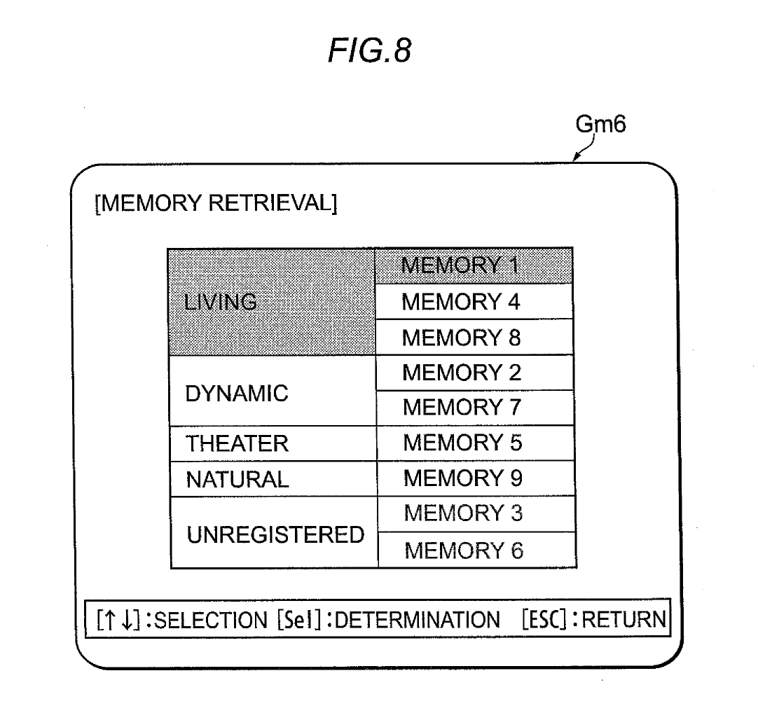

FIG. 8 is an explanatory diagram showing the OSD image displayed in retrieving the parameter set.

The memory retrieval menu image Gm6 shown in FIG. 8 is generated by the OSD processing section 27 in response to the control section 20 retrieving the parameter representing the color mode corresponding to each of the identifiers from the storage section 21 and outputting the parameter and so on to the OSD processing section 27 as the OSD image information.

As shown in FIG. 8, in the memory retrieval menu image Gm6, there are listed in the vertical direction the parameters representing the color modes, and an identifier corresponding to each of the color modes is displayed on the right side of the respective one of the parameters. In other words, the nine identifiers (“memory 1” through “memory 9”) are in the condition categorized by the color mode. One of the nine identifiers is in the tentative selection condition, and the user can tentatively select another identifier by operating the upward/downward keys (“↑” and “↓”). It should be noted that if an identifier is tentatively selected, the identifier and the parameter corresponding to the identifier are displayed with the background color different from other items. Further, it is arranged that the identifiers (“memory 3” and “memory 6”) having no parameter set registered thereto out of the nine identifiers cannot tentatively selected, and is displayed with indistinctive color compared to other identifiers.

When the user operates the determination key (“Sel”) in the condition in which the desired identifier is tentatively selected, the control section 20 retrieves the parameter set corresponding to the present identifier from the storage section 21 and outputs it to the image data processing section 25. Thus, the image data processing section 25 starts the image quality adjustment on the image data in accordance with the parameter set.

As explained above, according to the projector 1 of the present embodiment, the following advantages can be obtained.

1. According to the projector 1 of the present embodiment, when prompting to select a parameter set to be retrieved out of the plurality of registered parameter sets, a parameter (the parameter representing the color mode) included in each of the parameter sets is displayed inside the memory retrieval menu image Gm6. Therefore, it becomes possible to know the content of each of the parameter sets, and accordingly, it becomes possible to predict the display condition in the case in which each of the parameter sets is used. As a result, convenience in selecting the desired set out of the plurality of parameter sets can be enhanced.

2. According to the projector 1 of the present embodiment, when prompting to select the parameter set to be retrieved out of the plurality of registered parameter sets, the parameter sets are displayed while being categorized by the parameter (the parameter representing the color mode) included in each of the parameter sets. Therefore, it becomes easy to select the parameter set including the desired color mode out of the plurality of parameter sets, thus enhancing convenience in selecting the parameter set.

### Second Embodiment

An image display device according to a second embodiment of the invention will hereinafter be explained with reference to the accompanying drawings.

It is arranged that, in registering the parameter set in the storage section 21, the control section 20 of the projector 1 as the image display device of the present embodiment stores information (input terminal information) representing the input terminal selected in the input source switching section 24 at that moment as one of the parameters in conjunction with the identifier. Further, it is arranged that, in retrieving the registered parameter set, the identifier and the name of the input terminal corresponding thereto are displayed in the menu image for prompting to select the desired parameter set.

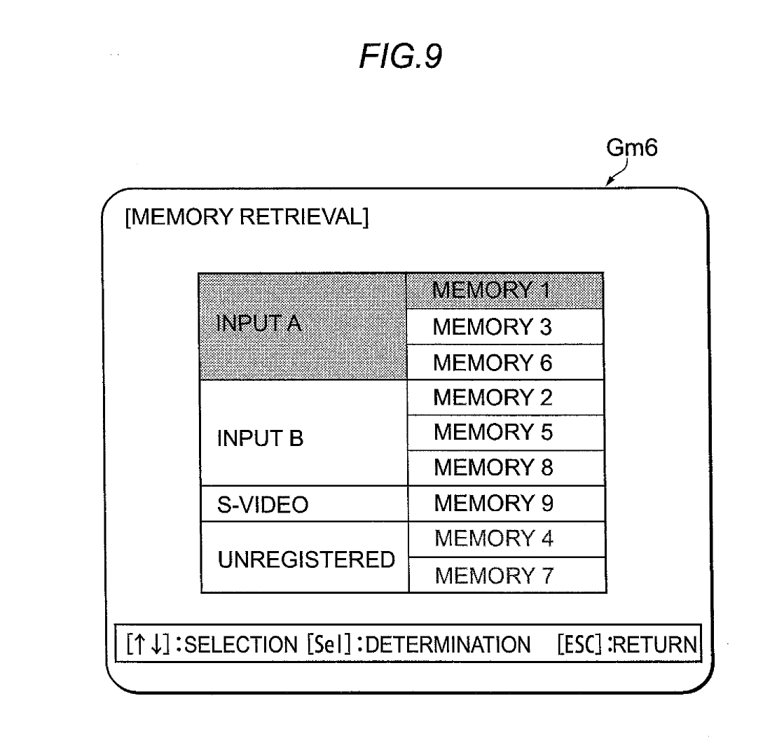

FIG. 9 is an explanatory diagram showing the OSD image displayed in retrieving the parameter set in the projector 1 of the present embodiment.

If “memory retrieval” is selected in the condition in which the memory operation menu image Gm4 (see FIG. 6) is displayed, the control section 20 instructs the OSD processing section 27 to display the OSD image (the memory retrieval menu image Gm6) as described in FIG. 9. Specifically, the control section 20 retrieves the input terminal information corresponding to each of the identifiers from the storage section 21, and outputs the input terminal information and so on to the OSD processing section 27 as the OSD image information. In response therewith, the OSD processing section 27 generates the OSD image data representing the memory retrieval menu image Gm6, and then superimposes it onto the input image data.

As shown in FIG. 9, in the memory retrieval menu image Gm6, there are listed in the vertical direction the input terminal manes, and an identifier corresponding to each of the input terminals is displayed on the right side of the respective one of the input terminal names. In other words, the nine identifiers (“memory 1” through “memory 9”) are in the condition categorized by the input terminal. One of the nine identifiers is in the tentative selection condition, and the user can tentatively select another identifier by operating the upward/downward keys (“↑” and “↓”). It should be noted that if an identifier is tentatively selected, the identifier and the input terminal name corresponding to the identifier are displayed with the background color different from other items. Further, it is arranged that the identifiers having no parameter set registered thereto out of the nine identifiers cannot tentatively selected, and is displayed with indistinctive color compared to other identifiers.

It should be noted that, immediately after the memory retrieval menu image Gm6 is displayed, the condition in which the identifier corresponding to the input terminal selected in the input source switching section 24 at that moment is tentatively selected is preferably established. Further, it can be arranged that, when selecting one of the identifiers in the memory retrieval menu image Gm6, the identifier can be selected only from the identifiers corresponding to the input terminal selected in the input source switching section 24 at that moment.

When the user operates the determination key (“Sel”) in the condition in which the desired identifier is tentatively selected, the control section 20 retrieves the parameter set corresponding to the present identifier from the storage section 21 and outputs it to the image data processing section 25. Thus, the image data processing section 25 starts the image quality adjustment on the image data in accordance with the parameter set.

As explained above, according to the projector 1 of the present embodiment, the following advantages can be obtained.

1. According to the projector 1 of the present embodiment, when prompting to select a parameter set to be retrieved out of the plurality of registered parameter sets, the input terminal name corresponding to each of the parameter sets is displayed inside the memory retrieval menu image Gm6. Therefore, it becomes easy to select the parameter set suitable for one of various types of image signals out of a plurality of parameter sets, thus enhancing convenience in selecting the parameter set.

2. According to the projector 1 of the present embodiment, when prompting to select the parameter set to be retrieved out of the plurality of registered parameter sets, the plurality of parameter sets is displayed while being categorized by the input terminal corresponding to each of the parameter sets. Therefore, it becomes much easier to select the parameter set suitable for the desired type of image signal out of the plurality of parameter sets.

For example, in the case in which the parameters are separately used for respective types of the image signals input to the input terminals, such as the composite terminal CN6 to which the image signal with average image quality is input, the HDMI terminal CN4 to which the image signal with high image quality is expected to be input, or 15-pin mini D-Sub terminal CN2 to which the image signal representing a still image is expected to be input from a computer and the like, it becomes possible to select the parameter set suitable for the image (the image signal) to be appreciated.

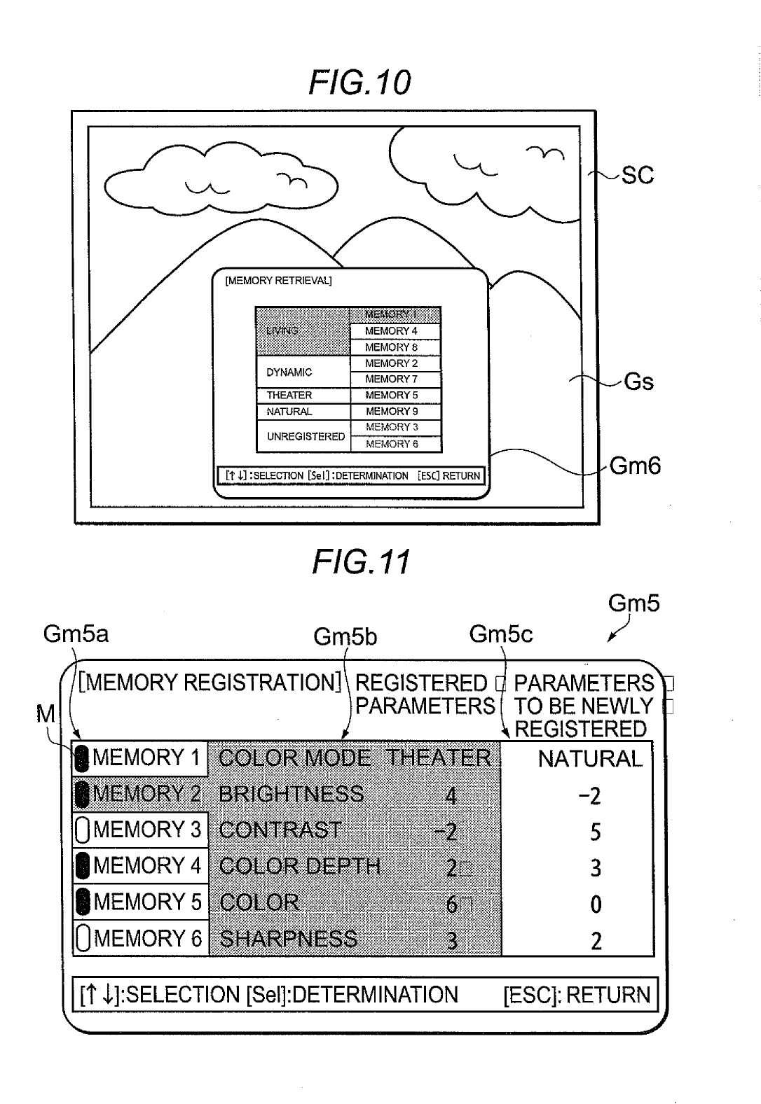

It should be noted that, in the first and the second embodiments, it can also be possible to execute the image quality adjustment based on the tentatively selected parameter set on the input image Gs displayed as the background while the memory retrieval menu image Gm6 is displayed (see FIG. 10). According to this configuration, it becomes possible to confirm the display condition in the case in which the tentatively selected parameter set is used by looking the actual screen, thus further enhancing convenience in selecting the parameter set.

### Third Embodiment

An image display device according to a third embodiment of the invention will hereinafter be explained with reference to the accompanying drawings.

The projector 1 as the image display device of the present embodiment is arranged to be able to compare the parameter included in the parameter set in presently use with the parameter included in the parameter set registered in the storage section 21 inside the memory registration menu image Gm5 or the memory retrieval menu image Gm6 while performing the memory registration or the memory retrieval.

FIG. 11 is an explanatory diagram showing the OSD image displayed in registering the parameter set in the projector according to the present embodiment.

If “memory registration” is selected in the condition in which the memory operation menu image Gm4 (see FIG. 6) is displayed, the control section 20 instructs the OSD processing section 27 to display the OSD image (the memory registration menu image) for registering the parameter set superimposed onto the input image Gs.

As shown in FIG. 11, the memory registration menu image Gm5 of the present embodiment is composed of a selection area Gm5a, a registered parameter display area Gm5b, a present parameter display area Gm5c, and so on. In the present embodiment, it is arranged that the storage section 21 can store six parameter sets, and in the selection area Gm5a of the memory registration menu image Gm5, there are arranged in the vertical direction identifiers (“memory 1” through “memory 6”) each corresponding to respective one of the six parameter sets described above. On the left side of each of the identifiers, there is attached a mark M representing a registration condition. Whether or not the parameter set corresponding to each of the identifiers has been registered can be judged with the color of the mark M (e.g., black represents the registered condition and white represents the unregistered condition).

One of the six identifiers is in the tentative selection condition, and the user can tentatively select another identifier by operating the upward/downward keys (“↑” and “↓”). By operating the determination key (“Sel”) after tentatively selecting an unregistered one of the identifiers, the user can store the parameter set in presently use in the storage section 21 in conjunction with the tentatively selected identifier.

Meanwhile, it is arranged that the parameter set in presently use can be overwritten to be registered in conjunction with an identifier to which another parameter set has already been registered. When the identifier to which another parameter set has already been registered is tentatively selected, the control section 20 retrieves the parameter set from the storage section 21 and instructs the OSD processing section 27 to display the adjustment item names and the respective parameters with the registered parameter display area Gm5b side-by-side. Further, in the present parameter display area Gm5c, the parameters included in the presently used parameter set to be registered are displayed with the registered parameters side-by-side so as to be able to be compared with each other in every item.

Thus, the user can compare the present parameter set to be registered with the registered parameter set to judge the sameness or the similarity therebetween, and can abandon the registration when the completely the same parameter set has already been registered, or can overwrite it when the similar parameter set has already been registered, thus suppressing the useless registrations. When the user operates the determination key (“Sel”) after tentatively selecting a desired one of the identifiers, the control section 20 stores the parameter set in presently use in the storage section 21 in conjunction with the tentatively selected identifier.

It should be noted that it is preferable to display each of the adjustment item names in the registered parameter display area Gm5b and to display the parameters presently used in the present parameter display area Gm5c even in the condition in which an unregistered identifier is tentatively selected.

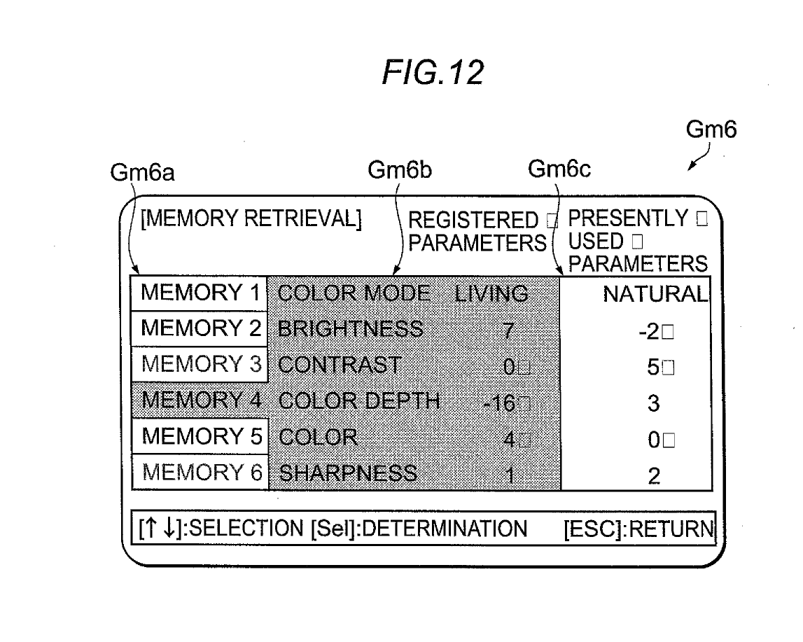

FIG. 12 is an explanatory diagram showing the OSD image displayed in retrieving the parameter set in the projector according to the present embodiment.

If “memory retrieval” is selected in the condition in which the memory operation menu image Gm4 is displayed (see FIG. 6), the control section 20 instructs the OSD processing section 27 to display the OSD image (a memory retrieval menu image) for retrieving the registered parameter set superimposed on the input image Gs.

As shown in FIG. 12, the memory retrieval menu image Gm6 of the present embodiment is composed of a selection area Gm6a, a registered parameter display area Gm6b, a present parameter display area Gm6c, and so on. In the selection area. Gm6a, there are listed six identifiers (“memory 1” through “memory 6”) in the vertical direction, one of which is in the tentative selection condition. Further, it is arranged that the identifiers (“memory 3” and “memory 6”) having no parameter set registered thereto out of the six identifiers cannot tentatively selected, and is displayed with indistinctive color compared to other identifiers.

When the user tentatively selects either one of the identifiers to which other parameter sets have already been registered by operating the upward/downward keys (“↑” and “↓”), the control section 20 retrieves the parameter set from the storage section 21 and instructs the OSD processing section 27 to display the adjustment item names and the respective parameters with the registered parameter display area Gm6b side-by-side. Further, in the present parameter display area Gm6c, the parameters included in the presently used parameter set are displayed with the registered parameters side-by-side so as to be able to be compared with each other in every item.

Accordingly, the user can easily predict the display condition in the case in which the image quality adjustment is performed based on the registered parameter set by comparing the parameter set in presently use with the registered parameter set to be retrieved to recognize the difference therebetween, thus enhancing convenience in selecting the desired parameter set.

When the user operates the determination key (“Sel”) in the condition in which the desired identifier is tentatively selected, the control section 20 outputs the parameter set corresponding to the identifier to the image data processing section 25, and the image data processing section 25 then starts the image quality adjustment based on the parameter set on the input image data.

As explained above, according to the projector 1 of the present embodiment, the following advantages can be obtained.

1. According to the projector 1 of the present embodiment, when prompting to select the identifier to which the parameter set should be registered, namely prior to storing the parameter set in the storage section 21, the parameters included in the parameter set and the parameters included in the tentatively selected one of the registered parameter sets are displayed in the memory registration menu image Gm5, thus the parameters included in the both parameter sets can be compared with each other. As a result, it becomes easy to confirm whether or not a parameter set, which is the same as or similar to the parameter set to be registered, has already been registered, thus it can be suppressed to register a plurality of the same or similar parameter sets.

2. According to the projector 1 of the present embodiment, when prompting to select one parameter set to be retrieved out of the plurality of registered parameter sets, the parameters included in the parameter set in presently use and the parameters included in the tentatively selected one of the registered parameter sets are displayed in the memory retrieval menu image Gm6, thus making it possible to compare the parameters included in the both of the parameter sets with each other. This comparison makes it easy to predict the display condition (the difference from the present display condition) in the case in which each of the registered parameter sets is used, thus enhancing convenience in selecting desired one from the plurality of parameter sets.

### Fourth Embodiment

An image display device according to a fourth embodiment of the invention will hereinafter be explained with reference to the accompanying drawings.

A projector 1 as the image display device of the present embodiment allows comparing the parameters with the memory registration menu image Gm5 or the memory retrieval menu image Gm6 when performing the memory registration or the memory retrieval, and is further arranged to allow comparing the display condition with the parameter set in presently use with the display condition with the parameter set registered in the storage section 21.

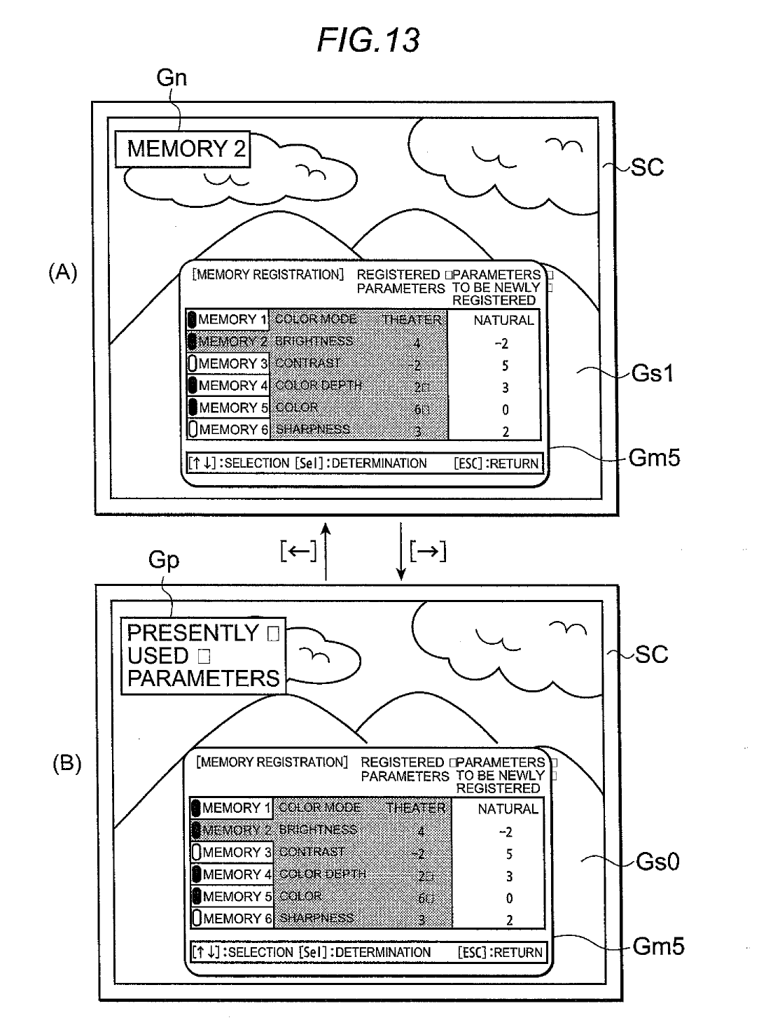

FIGS. 13A and 13B are explanatory diagrams showing projection images of the projector according to the present embodiment, and represent the images projected on the screen SC in the memory registration.

When the identifier to which the parameter set is registered is tentatively selected with the upward/downward keys (“↑” and “↓”) in the condition in which the memory registration menu image Gm5 is displayed, the control section 20 retrieves the parameter set corresponding to the identifier from the storage section 21, and displays the content (parameters) and the content of the parameter set in presently use in the memory registration menu image Gm5 similarly to the third embodiment.

In addition thereto, as shown in FIG. 13A, the control section 20 outputs the retrieved parameter set to the image data processing section 25 to instruct it to display the image Gs1 obtained by executing the image quality adjustment based on the parameter set on the input image data as the background of the memory registration menu image Gm5. Further, in order for showing that the image quality of the displayed image Gs1 is adjusted based on the registered parameter set, the control section 20 instructs the OSD processing section to display the OSD image Gn representing the identifier corresponding to the parameter set superimposed onto the input image Gs.

In this case, when the user operates the rightward key (“→”) in the condition in which the registered identifier is tentatively selected, namely, in the condition in which the image Gs1 is displayed as the background of the memory registration menu image Gm5, the control section 20 instructs the image data processing section 25 to display the image Gs0, on which the image quality adjustment based on the parameter set is performed, as the background of the memory registration menu image Gm5 by outputting the presently used (unregistered) parameter set to the image data processing section 25 as shown in FIG. 13B. Further, in order for showing that the image quality adjustment based on the parameter set in presently use is performed on the displayed image Gs0, the control section 20 instructs the OSD processing section 27 to display the OSD image Gp representing “present parameters” instead of the OSD image Gn.

Further, the user operates the leftward key (“←”) in the condition in which the image Gs0 based on the parameter set in presently use is displayed in the background of the memory registration menu image Gm5, the control section 20 restores the condition in which the image Gs1 based on the tentatively selected one of the registered parameter sets. Namely, the user can compare the parameter set in presently use with the registered parameter set while looking at the actual images Gs0 and Gs1 by alternately operating the leftward/rightward keys (“←” and “→”).

It should be noted that, although omitted from the drawings, also while displaying the memory retrieval menu image Gm6, the image Gs0 on which the image quality adjustment based on the parameter set in presently use is executed and the image Gs1 on which the image quality adjustment based on the tentatively selected one of the registered parameter sets is executed can be displayed as the background of the memory retrieval menu image Gm6 while switching therebetween by alternately operating the leftward/rightward keys (“←” and “→”), thus the user can compare the parameters on the both sides while looking at the actual images Gs0 and Gs1 even at the time of the memory retrieval.

As explained above, according to the projector 1 of the present embodiment, the following advantages can be obtained in addition to the advantages in the third embodiment.

1. According to the projector 1 of the present embodiment, when prompting to select the identifier to which the parameter set is registered, namely prior to storing the parameter set in the storage section 21, the image Gs0 adjusted based on the parameter set and the image Gs1 adjusted based on the tentatively selected one of the registered parameter sets are displayed while switching therebetween in accordance with the key operation. As a result, the both parameter sets can be compared while looking at the actual images Gs0 and Gs1, thus making it much easier to confirm whether or not the same or a similar parameter set has already been stored.

2. According to the projector 1 of the present embodiment, when prompting to select the parameter set to be retrieved out of the plurality of registered parameter sets, the image Gs0 adjusted based on the parameter set in presently use and the image Gs1 adjusted based on the tentatively selected one of the registered parameter sets are displayed while switching therebetween in accordance with the key operation. Namely, the display condition in the case in which the registered parameter set is used can be confirmed by looking at the actual image Gs1, and further compared with the image Gs0 based on the parameter set in presently use, thus enhancing convenience in selecting desired one out of the plurality of parameter sets.

### Fifth Embodiment

An image display device according to a fifth embodiment of the invention will hereinafter be explained with reference to the accompanying drawings.

A projector 1 as the image display device of the present embodiment is arranged to be capable of comparing the display condition with the parameter set in presently use and the display condition with the registered parameter set by the image displayed as the background of each of the menu images Gm5 and Gm6 at the time of the memory registration and the memory retrieval similarly to the fourth embodiment.

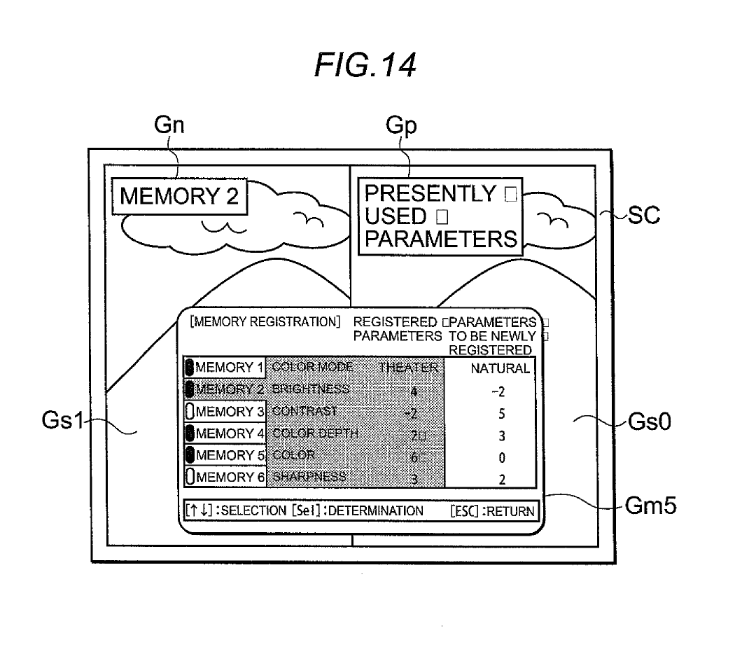

FIG. 14 is an explanatory diagram showing the projection image of the projector according to the present embodiment, and represents the image projected on the screen SC in the memory registration.

When the identifier to which the parameter set is registered is tentatively selected with the upward/downward keys (“↑” and “↓”) in the condition in which the memory registration menu image Gm5 is displayed, the control section 20 retrieves the parameter set from the storage section 21, and displays the content (parameters) and the content of the parameter set in presently use in the memory registration menu image Gm5 similarly to the third embodiment.

In addition thereto, as shown in FIG. 14, the control section 20 instructs the image data processing section 25 to generate, for example, image data for displaying the left half of the original input image Gs disposed on both the left and the right sides, wherein the right side image data representing the image Gs0 is processed with the image quality adjustment based on the parameter set in presently use and the left side image data representing the image Gs1 is processed with the image quality adjustment based on the tentatively selected and retrieved parameter set to display the images Gs0 and Gs1 in the background of the memory registration menu image Gm5. Further, the control section 20 instructs the OSD processing section 27 to superimpose the OSD image Gp representing “present parameter” onto the image Gs0 and the OSD image Gn representing the identifier corresponding to the registered parameter set onto the image Gs1 in order for showing that the images Gs0 and Gs1 are adjusted in the image quality based on the parameter set in presently use and the registered parameter set, respectively.

It should be noted that, although omitted in the drawings, while displaying the memory retrieval menu image Gm6, the image Gs0 processed with the image quality adjustment based on the parameter set in presently use and the image Gs1 processed with the image quality adjustment based on the tentatively selected one of the registered parameter sets are displayed horizontally side-by-side as the background thereof.

As explained above, according to the projector 1 of the present embodiment, the following advantages can be obtained in addition to the advantages in the third and the fourth embodiment.

According to the projector 1 of the present embodiment, when prompting to select the identifier to which the parameter set is registered, or when prompting to select the parameter set to be retrieved out of the plurality of registered parameter sets, the image Gs0 adjusted based on the parameter set in presently use and the image Gs1 adjusted based on the registered parameter set are displayed simultaneously, thus making it easy to compare the both sides.

It should be noted that in the first through the fifth embodiments, the control section 20 instructing to display the memory retrieval menu image Gm6 for prompting the user to select the desired parameter set corresponds to the selection section of the invention, and the control section 20 instructing to display the memory registration menu image Gm5 for registering the parameter set in presently use corresponds to the registration section of the invention. Further, the control section instructing to display the menu image (the image quality adjustment menu image Gm1, the color mode selection menu image Gm2, and the numerical value adjustment menu image Gm3) for changing the parameters corresponds to the parameter change section of the invention. Further, the control section 20, the input operation section 22, the remote controller RC, the input source switching section 24 are used for selecting the input terminal from which the image signal is input in accordance with the user operation, and accordingly correspond to the input selection section of the invention.

### Modified Example

Note that the embodiments of the invention can be modified as follows.

Although in the memory retrieval menu image Gm6 (see FIGS. 8 and 9) of the first and the second embodiments, the identifiers for representing the parameter sets are displayed while categorized by the color mode or the input terminal, they do not necessarily need to be thus categorized providing the color mode or the input terminal name corresponding to each of the identifiers is specified as is the case for the memory registration menu image Gm5 (see FIG. 7).

Although in the first and the second embodiments, only one parameter (the parameter representing the color mode) out of the parameters included in the registered parameter set is displayed in the memory registration menu image Gm5 (see FIG. 7), the number of displayed parameters is not limited to one, but it can also be arranged that a plurality of parameters is displayed. Further, in the first embodiment (see FIG. 8), one or more of the parameters other than the color mode can also be described together with each of the identifiers in the memory retrieval menu image Gm6, and in the second embodiment (see FIG. 9), one or more of the parameters other than the input terminal name can also be described together with each of the identifiers in the memory retrieval menu image Gm6.

Although in the third through the fifth embodiments, the plurality of parameters included in the parameter set in presently use and the plurality of parameters included in the registered parameter set are displayed in the memory registration menu image Gm5 or the memory retrieval menu image Gm6, the number of the displayed parameters is not limited to plural numbers, but it can also be arranged to display only one parameter (e.g., color mode).

Although in the third through the fifth embodiments, only the parameters included in one parameter set, which is tentatively selected, are displayed as the registered parameters displayed in the memory registration menu image Gm5 or the memory retrieval menu image Gm6, it can also be arranged to display the parameters included in a plurality of parameter sets.

In the fourth and the fifth embodiments, it can also be arranged to limit the images Gs0 and Gs1 displayed in the background of the menu images Gm5 and Gm6 to still images regardless of the type (moving image or still image) of the input image so that the two images Gs0 and Gs1 can strictly be compared with each other. As the still image, an image obtained by capturing the input image (a moving image) or a previously prepared (stored in the storage section 21 or the like) image can be used.

Although in the first through fifth embodiments, the parameter set is composed only of the parameters relating to the image quality adjustment, it can also be composed of a parameter representing the screen size (the aspect ratio), a parameter for adjusting the optical system, and so on.

Although in the first through the fifth embodiments, the projector 1 is explained as an example of the image display device, it can also be applied to other image display devices such as a liquid crystal display device.

What is claimed is:

1-11. (canceled)

12. An image display device for adjusting an image based on a parameter set including a plurality of parameters and displaying the adjusted image, comprising:
a storage section that stores a plurality of the parameter sets;
a selection section that prompts to select desired one of the plurality of parameter sets stored in the storage section; and
an image adjustment section that obtains the parameter set selected by the selection section and adjusts a display condition of the image based on the obtained parameter set,
wherein the selection section displays a first image corresponding to the parameters included in the parameter set used presently and a second image corresponding to the parameters included in the parameter set stored in the storage section when prompting to select the desired one of the plurality of parameter sets simultaneously.

13. The image display device according to claim 1, wherein the selection section displays an image adjusted based on the parameter set used presently, and an image adjusted based on the parameter set stored in the storage section when prompting to select the desired one of the plurality of parameter sets.

14. The image display device according to claim 2, wherein the selection section displays the image adjusted based on the parameter set used presently, and the image adjusted based on the parameter set stored in the storage section simultaneously.

15. An image display device for adjusting an image based on a parameter set including a plurality of parameters and displaying the adjusted image, comprising:
a parameter change section that changes the parameters;
a storage section capable of storing a plurality of the parameter sets; and
a registration section that stores, in the storage section, the parameter set including the parameter changed by the parameter change section,
wherein the registration section displays, prior to storing the parameter set in the storage section, a first image corresponding to the parameters included in the parameter set to be stored and a second image corresponding to the parameters included in the parameter set that has already been stored in the storage section simultaneously.

16. The image display device according to claim 4, wherein the registration section displays, prior to storing the parameter set in the storage section, an image adjusted based on the parameter set to be stored and an image adjusted based on the parameter set that has already been stored in the storage section.

17. The image display device according to claim 5, wherein the registration section displays the image adjusted based on the parameter set to be stored, and the image adjusted based on the parameter set that has already been stored in the storage section simultaneously.

18. A projector functioning as the image display device according to claim 1.
